(19) United States
(12) Patent Application Publication
(10) Pub. No.: US 2014/0238342 A1
(43) Pub. Date: Aug. 28, 2014

(54) RIM FIRE SPARKING GASKET

(71) Applicant: Agajanian Performance Products, San Pedro, CA (US)

(72) Inventors: Chris Agajanian, Torrance, CA (US); Brian Bevan, Torrance, CA (US); Ian Bland, Torrance, CA (US)

(73) Assignee: AGAJANIAN PERFORMANCE PRODUCTS, San Pedro, CA (US)

(21) Appl. No.: 14/149,760

(22) Filed: Jan. 7, 2014

Related U.S. Application Data
(60) Provisional application No. 61/749,823, filed on Jan. 7, 2013.

(51) Int. Cl. F02P 15/08

(52) U.S. Cl. CPC F02P 15/08
USPC 123/310

(57) ABSTRACT

The sparking gasket amalgamates two traditional parts of the internal combustion engine into one unit by replacing the spark plug with electrode circuitry embedded into the gasket material. This system provides reduced hydrocarbon emissions by improving combustion thus giving a cleaner burn with increased fuel economy and improved engine performance. The new materials being used have greatly increased gasket life by reducing material deterioration and insulation breakdown that lead to engine failure. Further improvements in electrode design, materials and positioning have led to improved efficiency gains. In this design the electrode circuitry is fused between two material wafers thus encapsulating it in one solid bonded unit.

### BACKGROUND

This patent application claims priority to United States Provisional Patent Application Number 61/749,823 filed on Jan. 7, 2013, which is incorporated by reference herein in its entirety.

Internal combustion engines operate by igniting fuel in a cylinder, causing the linear movement of a piston in the cylinder. This linear movement is translated to circular movement by a crank-shaft, eventually causing a drive shaft to rotate, allowing the engine to impart motion to a vehicle. The ignition of the fuel mixture in the cylinder is caused by the introduction of a spark, resulting in combustion. The spark, in turn, is produced at the tip of a spark plug that is positioned within the chamber of the cylinder.

Nikola Tesla and Robert Bosch both patented a spark plug design in 1898. The current version of the spark plug was patented in 1902 by Gottlob Honold. Although the design has been modified over the years, most internal combustion engines today use sparking technology that is over 100 years old.

There are disadvantages of the current sparkplug implementation such as incomplete combustion, fuel inefficiency, excess emissions, and the like. Current spark plug design places a spark plug in a threaded hole at the centre of the engine head. This design propagates the combustion flame from the center evenly out to the walls of the cylinder. However, the cylinder walls are externally cooled and therefore cause a cold spot that tends to extinguish the flame before combustion is fully completed. This results in a loss of power, increased fuel consumption and high hydrocarbon emissions.

One attempt to solve these problems is the replacement of the sparkplug with a multi-electrode system that is incorporated into an existing element of the internal combustion engine, namely the head gasket. The head gasket normally provides a seal of the cylinders, preventing the leakage of other fluids (coolant, engine oil) into the cylinders, while still maintaining the maximum compression available in the system, allowing peak designed efficiency. The prior art has modified the head gasket by introducing sparking electrodes into the system into a device referred to as a “sparking gasket”.

The sparking gasket incorporates one or more electrode circuits into the head gasket. The multiple spark electrodes in theory allow for much faster ignition of the fuel mixture in the cylinder chamber, allowing for more complete combustion (reducing emissions and increasing fuel efficiency) and faster burning (allowing for more power).

In practical applications the sparking gasket has proved to be unreliable due to breakdown of the gasket material itself due to the higher demands placed upon it by the new technology. The hot spots created by the sparking electrodes cause a breakdown in the gasket material itself, so that its primary function, sealing and compression, is severely compromised.

One attempt to solve the material breakdown problem is described in U.S. Pat. No. 5,046,466 that describes a multi-layer approach to the sparking gasket construction. However, the design and materials described in the '466 patent have not solved the prior art problems of degradation, deterioration, and material failure.

### SUMMARY

The sparking gasket of the present system replaces the standard spark plug with multiple built in sparking probes situated in each chamber. This provides significant improvements in fuel economy, performance, emission reduction, and material cost savings. The sparking gasket will have a number of ignition electrodes placed strategically around the cylinder to facilitate a more efficient combustion corresponding to the cylinder design. This allows a more efficient, faster ignition, with a more complete or cleaner burn due to the proximity of the electrodes during engine stroke. The sparking gasket comprises composite materials that encapsulate the electrode circuitry, eliminating conductivity to the engine body while providing significant insulation and rigidity to hold the metallic electrodes in the optimum position. The composition also provides all of the sealing and compression maintaining properties of prior art non-sparking gaskets. An improved design utilizes standard fastening devices to provide circuit grounding without the need for more complex circuitry.

### BRIEF DESCRIPTION OF THE DRAWINGS

FIG. 1 is a cutaway of the laminated circuit exposing the encapsulated circuitry.

FIG. 2 is a side view of a laminate structure of the gasket assembly of an embodiment of the system.

FIG. 3 illustrates an embodiment of a cylinder/head combination using the system.

FIG. 4 is an embodiment of a gasket assembly of the system.

FIG. 5 illustrates a conductor pattern in an embodiment of the system.

FIG. 6 illustrates a method for stabilizing the conductor pattern during production in an embodiment of the system.

FIG. 7 illustrates an alternate embodiment of a conductor pattern.

### DETAILED DESCRIPTION OF THE SYSTEM

The sparking gasket of the system comprises a composition and structure that allows for its use as a source of ignition sparks in an internal combustion engine while still acting as a suitable gasket material, providing required specification sealing and compression functionality and providing adequate operational lifetime.

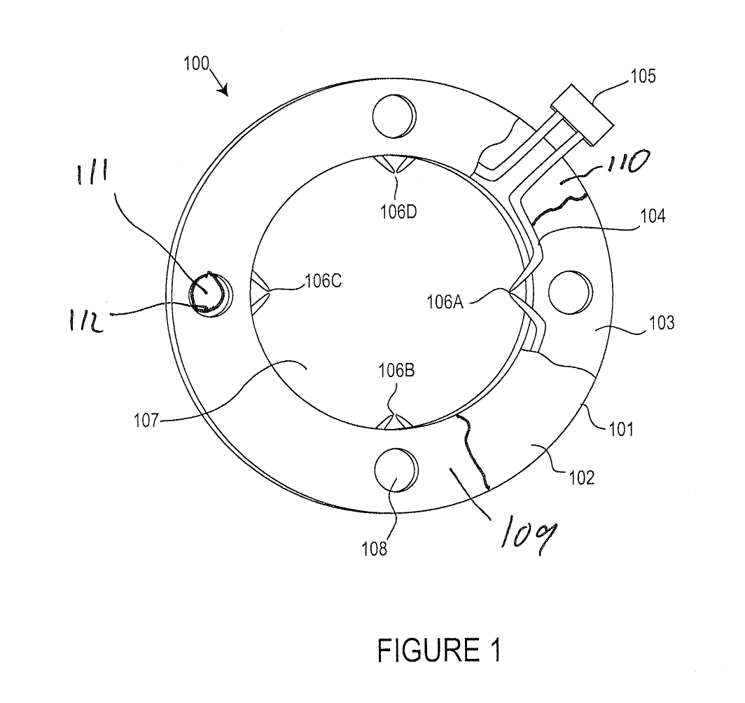

FIG. 1 illustrates an embodiment of the system. The system 100 comprises a gasket 101 that is an annular ring disposed on the top of a cylinder and provides sealing between the cylinder and other portions of the engine assembly. The gasket includes a plurality of layers, including top layer 109 and bottom layer 110, along with inner layers 102 and 103.

It should be noted that the system may be implemented with any number of layers and is not limited to the number of layers given in the examples herein. A conductor pattern 104 is formed or disposed between the inner layers 102 and 103 of the gasket 101 and is formed such that it defines a plurality of sparking electrodes 106A-106D extending somewhat into the interior of the cylinder chamber 107.

The electrodes 106A-106D each instantiate a gap between two conductors so that upon the introduction of current into the system, a spark is formed between the tips of the electrodes and across the gap, providing the source for igniting a fuel mixture in the cylinder chamber. Although the example of FIG. 1 shows the use of four electrodes disposed symmetrically about the cylinder chamber, this is given by way of example only. Other numbers and configurations of sparking electrodes can be implemented without departing from the scope and spirit of the system.

A connector 105 is used to join the conductive system of the sparking gasket 101 with the electrical system of the engine. The connector extends beyond the gasket material and the laminate layers are sealed around the extending conductors to prevent openings that could allow fluid transfer across the gasket boundary and at the same time to provide insulative protection to prevent electrical short circuits, arcing, and the like.

Improved Grounding Design

In one embodiment, openings 108 are formed in the gasket assembly that provide access to threaded holes that allow the connection of the head assembly to the cylinder assembly through the use of bolts, with the gasket 101 providing the seal between the two components. One of the openings 111 is designed to create a ground so as to complete the circuit in one embodiment. That grounding hole 111 of the gasket is created by allowing part of the bare embedded circuitry 112 to extend into the circumference of opening 111 so as to make adequate contact with a bolt passing thru it so as to create a ground. This provides grounding without the need for an additional conductor circuit in the gasket. Alternatively, an additional conductor extends from the gasket to provide ground by coupling it to the engine.

This provides improved operation over previous designs where the ground electrode required a separate connector and or appropriate positioning to maintain contact with a grounding body. The present system allows for some movement of the gasket relative to the cylinder without affecting the contact of the ground connection. The ground conductor extends sufficiently into the opening 111 so that an inserted bolt will always contact it when emplaced. The mass of the bolt and the force applied during insertion will allow the bolt to be inserted without interference of the conductor, even perhaps slightly deforming the extending ground connection during the insertion process, while still maintaining the ground connection.

Conductor Patterns

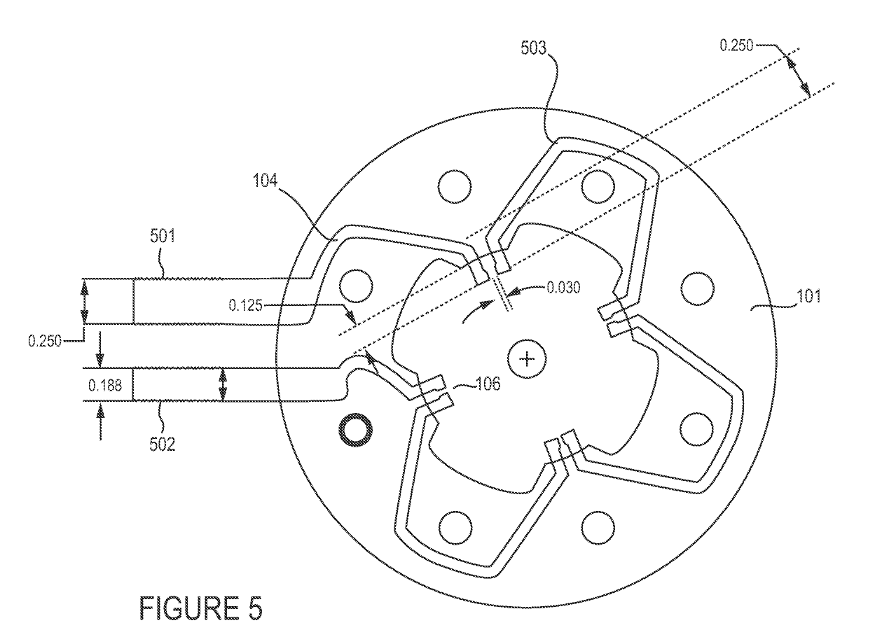

FIG. 5 illustrates a conductor pattern in an embodiment of the system. In this configuration, a separate load connector 501 and ground connector 502 are provided. The conductor pattern 104 is comprised of separate members, such as member 503. Member 503 is substantially “U” shaped and terminates at spark gap terminals 106. The potential difference between the load and ground cause a near simultaneous sparking across the spark gap terminals, providing more uniform combustion.

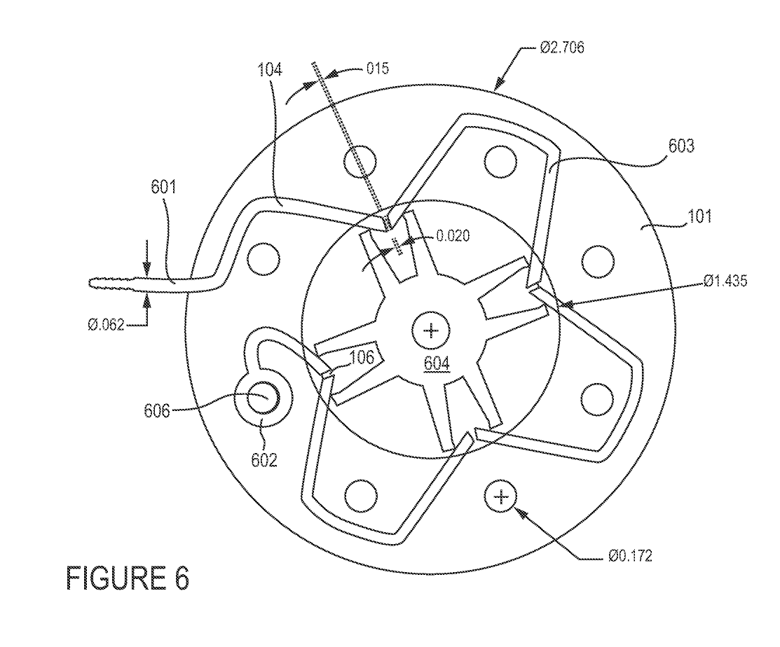

FIG. 6 illustrates a conductor path embodiment with the improved grounding system. FIG. 6 illustrates the load connector 601 that extends beyond the periphery of the gasket 101. The ground connector 602 is formed about the through-hole 606 and provides one side of the spark gap terminals 106. As with the example of FIG. 5, the conductor pattern may consist of “U” shaped segments 603, although other patterns may be used.

FIG. 6 also illustrates a retainer 604 that is used to aid in retaining the conductors and spark gap terminals in place during the lamination and processing steps in forming the gasket assembly. Once the gasket assembly has been formed, the retainer 604 can be removed.

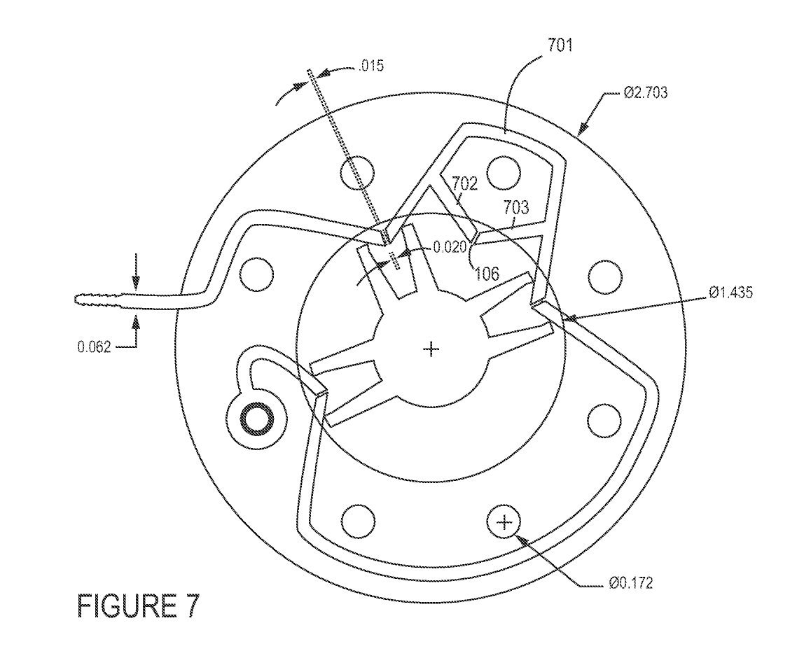

FIG. 7 illustrates an alternate conductor pattern. In this embodiment, conductors 702 and 703 can extend from the arms of “U” shaped pattern 701 to define spark gap terminals 106. In this example, the spark gap terminals are located somewhat asymmetrically on one side of the central circular opening of the gasket assembly.

The examples shown are where the conductor pattern is a series path. In an alternate embodiment, the conductors may be arranged for a parallel electrical circuit.

Gasket Composition

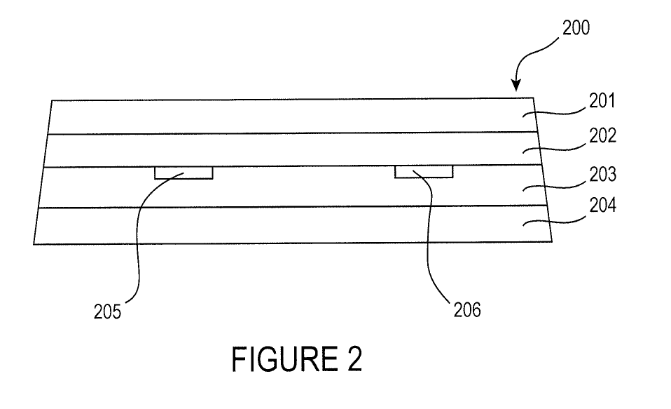

The system solves the problems of the prior art by the composition and construction of the sparking gasket. In one embodiment, the gasket is comprised of a laminate structure as shown in FIG. 2. The gasket assembly 200 is comprised of a plurality of layers. The outer laminate layers 201 and 204 provide the sealing and compression maintaining properties and are comprised of materials including ceramic, metallurgical, polymeric and composites, including high temperature (liquid and/or flexible) ceramics as well as organic and inorganic polymers formed during the development cycle. One embodiment implements layers 201 and 204 as a structure of ceramic impregnated Teflon. In operation, the layers 201 and 204 should be compressible so as to create a desired seal when installed between the cylinder and the cylinder head.

The electrodes 205 and 206 are implemented between two inner layers 202 and 203. In one embodiment layers 202 and 203 comprise resin materials such as phenol or polyamide-imide resin. The electrodes and/or electrode tips can be implemented using platinum or gold/palladium for durability and to reduce voltage requirements.

The structure can be fabricated in any manner, including one embodiment using high temperature press molding technologies.

Dimensions

The gasket assembly can be any of a variety of thicknesses without departing from the scope and spirit of the system. In one embodiment, the gasket is approximately 0.064 inches thick after fabrication, and compresses to approximately 0.050 inches at installation. The gasket can have a range of 0.030 to 0.200 inches. The electrodes can be approximately 0.030 inches but may also be within a range of 0.010 to 0.100 inches in thickness.

The individual laminate layers may be approximately equal in thickness. In one embodiment, the outer layers are thicker than the inner layers, and in another embodiment, the outer layers are thinner than the inner layers. The system should be able to perform at temperatures up to 1100 degrees F., and at pressures up to approximately 1200 PSI.

Cylinder Assembly

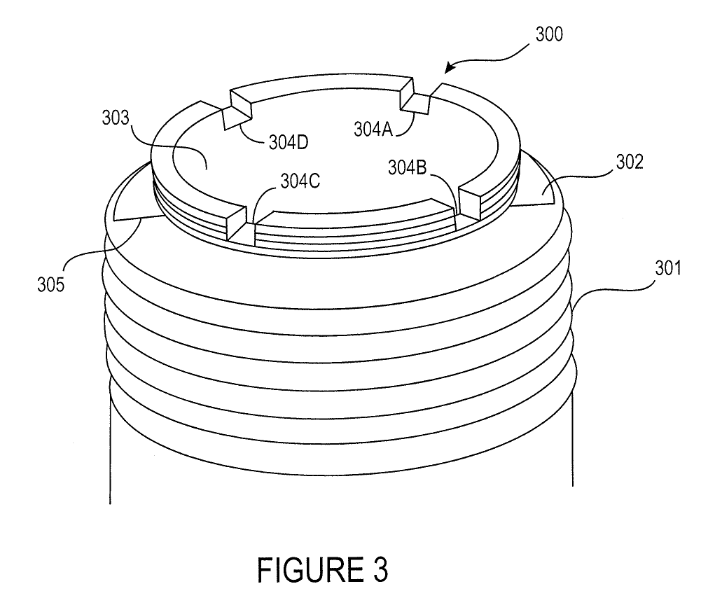

In the prior art, a spark plug is designed to be periodically replaced by unscrewing it from its position in the motor and replacing it with another spark plug. In the present system, the gasket typically cannot be removed without disassembly of a plurality of components. FIG. 3 illustrates an improved cylinder design that allows for easier replacement of a gasket of the system.

The cylinder 301 includes an upper portion that is a raised annular portion 303 so that an annular edge 302 is defined on the top of the cylinder. The raised portion 303 includes a plurality of defined slots 304A-304D (for example). The upper portion 303 includes threads 305 designed to receive a cooperatively threaded cap to seal the cylinder and gasket assembly in place.

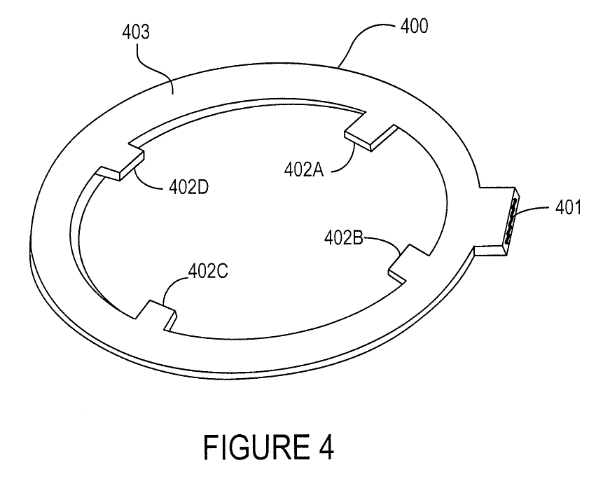

FIG. 4 illustrates an embodiment of a gasket assembly for use with the embodiment of FIG. 3. The gasket 400 includes an outer tab 401 for providing an electrical connection to the conductor pattern formed in the gasket 400. The gasket 400 includes a plurality of tabs 402A-402D for being received by, and to be registered by, slots 304A-304D respectively. Each of the tabs includes a protruding spark gap electrode (Not shown in FIG. 4). The annular edge 302 receives the ring portion 403 of the gasket 400 when the tabs are inserted into the slots. At this point, the threaded cap can be attached to the assembly to retain the gasket in place. It should be noted that the screw cap cylinder assembly can be used with or without the sparking gasket. It can be used with a traditional spark plug configuration.

Although we have shown the gasket assembly as substantially circular, it should be noted that other configurations may be utilized without departing from the scope and spirit of the system.

Thus, a sparking gasket has been described.

What is claimed is:

1. An apparatus comprising:
a gasket having a plurality of openings therein,
a conductor pattern formed within the gasket and defining a plurality of gapped electrodes about an interior of the gasket;
a ground conductor formed within the gasket and extending partially into at least one of the openings.

2. The apparatus of claim 1 wherein the gasket comprises a plurality of layers.

3. The apparatus of claim 2 wherein the gasket comprises an upper and a lower layer comprising a compressible insulative material.

4. The apparatus of claim 3 wherein the gasket comprises first and second inner layers disposed between the upper and lower layer and surrounding the conductor pattern.

5. The apparatus of claim 4 wherein the plurality of gapped electrodes comprises four electrodes.

6. The apparatus of claim 1 wherein the ground conductor forms a tip of one of the gapped electrodes at one end and extends partially into at least one of the openings at another end.

7. The apparatus of claim 3 wherein the upper and lower layer comprise at least one of a ceramic, metallurgical, polymeric, composite material, and ceramic impregnated Teflon.

8. The apparatus of claim 4 wherein the first and second inner layers comprise at least one of resin material, phenol resin, and polyamide-imide resin.

9. The apparatus of claim 1 wherein the conductor pattern comprises at least one of platinum, gold, and palladium.

10. The apparatus of claim 6 wherein a bolt for restraining the gasket contacts the ground conductor extending into the opening and a grounding body.
